(19) United States
(12) Patent Application Publication
(10) Pub. No.: US 2026/0278902 A1
(43) Pub. Date: Sep. 17, 2026

(54) VIDEO GENERATION METHOD AND RELATED APPARATUS

(71) Applicant: Tencent Technology (Shenzhen) Company Limited, Shenzhen (CN)

(72) Inventors: Huawei WEI, Shenzhen (CN); Zejun YANG, Shenzhen (CN)

(73) Assignee: Tencent Technology (Shenzhen) Company Limited, Shenzhen (CN)

(21) Appl. No.: 19/681,000

(22) Filed: May 18, 2026

Related U.S. Application Data
(63) Continuation of application No. PCT/CN2025/084277, filed on Mar. 24, 2025.

(30) Foreign Application Priority Data
May 7, 2024 (CN) 202410557277.8

(51) Int. Cl. G06T 13/40; G06T 13/20; G06T 17/20; G06V 40/16

(52) U.S. Cl. CPC G06T 13/40; G06T 13/205; G06T 17/20; G06V 40/168

(57) ABSTRACT

A video generation method includes obtaining a reference facial image and a to-be-converted content sequence. The reference facial image includes appearance features of a reference face. The to-be-converted content sequence includes a plurality of pieces of a to-be-converted content that changes over time. Each piece of the to-be-converted content indicates facial motion features of an original face associated with the to-be-converted content sequence. The method includes determining a mesh model of the reference face according to the reference facial image and determining a mesh parameter difference sequence according to the to-be-converted content sequence. The mesh parameter difference sequence indicates changes of the facial motion features over time. The method includes adjusting the mesh model of the reference face based on the mesh parameter difference sequence to obtain a facial mesh model sequence and generating a target video according to the facial mesh model sequence and the reference facial image.

### RELATED APPLICATIONS

The present application is a continuation of International Application No. PCT/CN2025/084277, filed on March 24, 2025, which claims priority to Chinese Patent Application No. 202410557277.8, filed on May 7, 2024. The entire disclosures of the prior applications are hereby incorporated by reference.

### FIELD OF THE TECHNOLOGY

This disclosure relates to the field of artificial intelligence technologies, including video generation.

### BACKGROUND OF THE DISCLOSURE

With the development of artificial intelligence technologies, a talking head video of a reference face (e.g., a target video) can be generated using a reference facial image including the reference face, thereby implementing live video streaming, video production, and the like.

In related technologies, a target video is usually generated using a model. Using a diffusion model as an example, motion coefficients related to expressions of an original face are extracted from a to-be-converted content sequence (such as audio or a video), and the reference facial image and the motion coefficients are inputted to the diffusion model. The diffusion model generates a series of image frames, thereby obtaining the target video.

However, the target video generated in the foregoing manner has poor quality, for example, the fusion between the reference face and the expression of the original face appears unnatural.

### SUMMARY

To address the foregoing technical problem, this disclosure includes a video generation method and related apparatus, to improve the quality of a generated target video.

Aspects of this disclosure disclose the following technical solutions.

According to an aspect, a video generation method includes obtaining a reference facial image and a to-be-converted content sequence. The reference facial image includes appearance features of a reference face. The to-be-converted content sequence includes a plurality of pieces of a to-be-converted content that changes over time. Each piece of the to-be-converted content indicates facial motion features of an original face associated with the to-be-converted content sequence. The video generation method includes determining a mesh model of the reference face according to the reference facial image and determining a mesh parameter difference sequence according to the to-be-converted content sequence. The mesh parameter difference sequence indicates changes of the facial motion features over time. The video generation method includes adjusting the mesh model of the reference face based on the mesh parameter difference sequence to obtain a facial mesh model sequence and generating a target video according to the facial mesh model sequence and the reference facial image.

According to an aspect of the disclosure, a video generation apparatus includes processing circuitry configured to obtain a reference facial image and a to-be-converted content sequence. The reference facial image includes appearance features of a reference face. The to-be-converted content sequence includes a plurality of pieces of a to-be-converted content that changes over time. Each piece of the to-be-converted content indicates facial motion features of an original face associated with the to-be-converted content sequence. The processing circuitry is configured to determine a mesh model of the reference face according to the reference facial image and determine a mesh parameter difference sequence according to the to-be-converted content sequence, the mesh parameter difference sequence indicating changes of the facial motion features over time. The processing circuitry is configured to adjust the mesh model of the reference face based on the mesh parameter difference sequence to obtain a facial mesh model sequence and generate a target video according to the facial mesh model sequence and the reference facial image.

According to an aspect of the disclosure, a non-transitory computer-readable storage medium storing instructions which when executed by at least one processor cause the at least one processor to perform obtaining a reference facial image and a to-be-converted content sequence. The reference facial image includes appearance features of a reference face. The to-be-converted content sequence includes a plurality of pieces of a to-be-converted content that changes over time. Each piece of the to-be-converted content indicates facial motion features of an original face associated with the to-be-converted content sequence. A mesh model of the reference face is determined according to the reference facial image. A mesh parameter difference sequence is determined according to the to-be-converted content sequence. The mesh parameter difference sequence indicates changes of the facial motion features over time. The mesh model of the reference face is adjusted based on the mesh parameter difference sequence to obtain a facial mesh model sequence. A target video is generated according to the facial mesh model sequence and the reference facial image.

According to one aspect, this disclosure provides a video generation method. A reference facial image and a to-be-converted content sequence are obtained. The reference facial image includes appearance features of a reference face. The to-be-converted content sequence includes a plurality of pieces of to-be-converted content that change over time. Each piece of to-be-converted content is used for indicating facial motion features of an original face. A mesh model of the reference face is determined according to the reference facial image. A mesh parameter difference sequence is determined according to the to-be-converted content sequence. The mesh parameter difference sequence is used for identifying differences between the facial motion features indicated by the plurality of pieces of to-be-converted content. The mesh model of the reference face is adjusted by using the mesh parameter difference sequence to obtain a facial mesh model sequence. A target video is generated according to the facial mesh model sequence and the reference facial image.

According to another aspect, a video generation apparatus is provided by this disclosure. The apparatus includes an obtaining unit configured to obtain a reference facial image and a to-be-converted content sequence. The reference facial image includes appearance features of a reference face. The to-be-converted content sequence includes a plurality of pieces of to-be-converted content that change over time. Each piece of to-be-converted content is used for indicating facial motion features of an original face. A first determining unit in the apparatus is configured to determine a mesh model of the reference face according to the reference facial image. A second determining unit in the apparatus is configured to determine a mesh parameter difference sequence according to the to-be-converted content sequence. The mesh parameter difference sequence is used for identifying differences between the facial motion features indicated by the plurality of pieces of to-be-converted content. An adjustment unit in the apparatus is configured to adjust the mesh model of the reference face by using the mesh parameter difference sequence to obtain a facial mesh model sequence. A generation unit in the apparatus is configured to generate a target video according to the facial mesh model sequence and the reference facial image.

According to another aspect, this disclosure provides a computer device including a processor and a memory. The memory is configured to store a computer program and transmit the computer program to the processor; and the processor is configured to execute the method described in the above aspect according to instructions in the computer program.

According to another aspect, this disclosure provides a computer-readable storage medium configured to store a computer program. The computer program is configured to execute the method described in the above aspect.

According to another aspect, this disclosure provides a computer program product or a computer program including computer instructions that are stored in a computer-readable storage medium. A processor of a computer device reads the computer instructions from the computer-readable storage medium and executes the computer instructions, to cause the computer device to execute the method described in the above aspect.

As can be seen from the foregoing technical solutions, a reference facial image and a to-be-converted content sequence are obtained. The reference facial image includes appearance features of a reference face. The to-be-converted content sequence includes a plurality of pieces of to-be-converted content that change over time, and each piece of to-be-converted content is used for indicating facial motion features of an original face. To generate a target video in which the reference face makes the facial motion features, a mesh model identifying the reference face may be determined according to the reference facial image, and a mesh parameter difference sequence is determined according to the to-be-converted content sequence. Since the mesh parameter difference sequence is used for identifying differences between the facial motion features indicated by the plurality of pieces of to-be-converted content, rather than reflecting facial contour parameters corresponding to each piece of to-be-converted content, the differences identified by the mesh parameter difference sequence effectively exclude facial features of the original face, while preserving the facial motion features of different pieces of to-be-converted content. After the mesh model of the reference face is adjusted by using the mesh parameter difference sequence, the resulting facial mesh model sequence not only accurately reflects the facial motion features associated with the to-be-converted content sequence, but also yields facial contours that better conform to the reference face, thereby avoiding facial contours that resemble those of the original face. The mesh model of the reference face is dynamically adjusted by using the time-varying facial motion features, so that the appearance features of the reference face in the adjusted facial mesh model sequence are better integrated with the facial motion features of the original face, thereby improving the quality of the target video.

### BRIEF DESCRIPTION OF THE DRAWINGS

FIG. 1 is a schematic diagram of an application scenario of a video generation method according to an aspect of this disclosure;

FIG. 2 is a schematic flowchart of a video generation method according to an aspect of this disclosure;

FIG. 3 is a schematic diagram of an application scenario of a video generation method according to an aspect of this disclosure;

FIG. 4 is a schematic diagram of an application scenario of a video generation method according to an aspect of this disclosure;

FIG. 5 is a schematic diagram of an audio conversion module according to an aspect of this disclosure;

FIG. 6 is a schematic diagram of a video conversion module according to an aspect of this disclosure;

FIG. 7 is a schematic diagram of a video generation module according to an aspect of this disclosure;

FIG. 8 is a schematic structural diagram of a video generation apparatus according to an aspect of this disclosure;

FIG. 9 is a schematic structural diagram of a server according to an aspect of this disclosure; and

FIG. 10 is a schematic structural diagram of a terminal device according to an aspect of this disclosure.

### DETAILED DESCRIPTION

The following describes the aspects of this disclosure with reference to the accompanying drawings.

Descriptions of terms in this disclosure are provided as examples only and are not intended to limit the scope of the disclosure.

In the specification, claims, and accompanying drawings of this disclosure, the terms "first", "second", "third", "fourth", and the like (if any) are intended to distinguish between similar objects, but do not necessarily indicate a specific order or sequence. Data used in such a way is interchangeable in a proper case, so that the aspects of this disclosure described herein can be implemented, for example, in a sequence other than the sequence illustrated or described herein. Moreover, the terms "include", "correspond to", and any other variants are intended to cover the non-exclusive inclusion. For example, a process, method, system, product, or device that includes a series of steps or units is not necessarily limited to those expressly listed steps or units, but may include other steps or units not expressly listed or inherent to the process, method, system, product, or device.

In the related technology, a target video generated based on a model has poor quality. Upon analysis, it has been found that regardless of whether the to-be-converted content sequence is a video or audio, the to-be-converted content sequence may carry facial motion features of an original face. For example, the video may directly include the original face. Although the audio does not directly include the original face, the audio may implicitly include facial motion features of a face that produces the sound. For instance, the volume and content of speech can lead to differences in expressions, head motion trajectories, and the like. For example, if the sound in the audio is consistently calm, the original face may remain still. However, the model in the related technologies uses fixed facial contour parameters to generate a target video. If the reference face in the reference facial image is significantly different from the original face in the to-be-converted content sequence, e.g., a similarity between the reference face and the original face is low, the fusion of a target face generated based on the reference face and the original face may be unnatural, resulting in poor quality of the generated target video.

Based on this, aspects of this disclosure include a video generation method and a related apparatus. Instead of using fixed facial contour parameters to generate a target video, dynamic adjustment is performed by using time-varying facial motion features, so that in a facial mesh model sequence obtained through adjustment, appearance features of the reference face are better fused with the facial motion features of the original face, thereby improving the quality of the target video generated based on the facial mesh model.

The video generation method provided in this disclosure may be applied to a computer device having a video generation capability, such as a terminal device or a server.

In various examples, the terminal device is a desktop computer, a notebook computer, a smartphone, a tablet computer, an Internet of Things device, a portable wearable device, or the like. The Internet of Things device may be a smart speaker, a smart television, a smart air conditioner, a smart in-vehicle device, or the like. The smart in-vehicle device may be an in-vehicle navigation terminal, an in-vehicle computer, or the like. The portable wearable device may be, but is not limited to, a smartwatch, a smart band, a head-mounted device, or the like.

The server may be an independent physical server, or a server cluster or a distributed system including a plurality of physical servers, or may alternatively be a cloud server or server cluster that provides a cloud service, a cloud database, cloud computing, a cloud function, cloud storage, a network service, cloud communication, a middleware service, a domain name service, a security service, a content delivery network (CDN), and a basic cloud computing service such as big data and an artificial intelligence platform. The terminal device may be connected directly or indirectly to the server in a wired or wireless communication manner. This is not limited in this disclosure.

To facilitate understanding of the video generation method provided in the aspects of this disclosure, an application scenario of the video generation method is described below by using an example in which the video generation method is executed by a server.

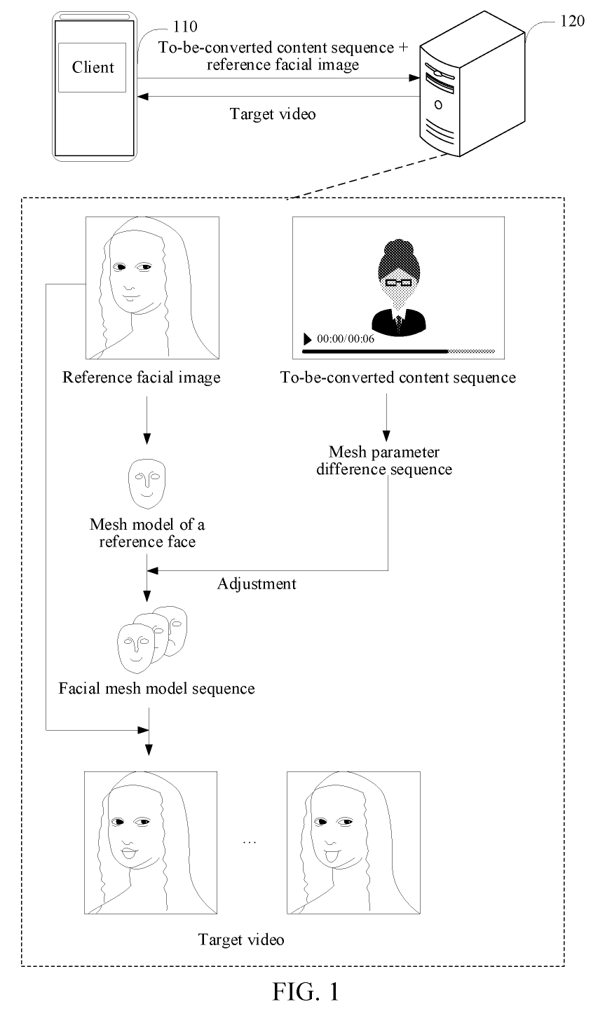

Referring to FIG. 1, FIG. 1 is a schematic diagram of an application scenario of a video generation method according to an aspect of this disclosure. As shown in FIG. 1, the application scenario includes a terminal (e.g., a terminal device) 110 and a server 120. The terminal 110 and the server 120 may communicate through a communication network. The communication network uses standard communication technologies and/or protocols, and is typically the Internet, or may be any network, including but not limited to any combination of Bluetooth, a local area network (LAN), a metropolitan area network (MAN), a wide area network (WAN), a mobile network, a dedicated network, or a virtual dedicated network. In some aspects, customized or dedicated data communication technologies may be used to replace or supplement the above data communication technologies.

For example, a video generation client may be installed in the terminal device 110. A user uploads a to-be-converted content sequence and a reference facial image by using the client. The reference facial image includes appearance features of a reference face. The to-be-converted content sequence includes a plurality of pieces of to-be-converted content that change over time. Each piece of to-be-converted content is used for indicating facial motion features of an original face. As shown in FIG. 1, the to-be-converted content sequence may be a video. The terminal device 110 transmits the to-be-converted content sequence and the reference facial image to the server 120.

The server 120 hosts a video generation server side, and is configured to provide a video generation service. After obtaining the reference facial image and the to-be-converted content sequence, the server 120 determines a mesh model of the reference face according to the reference facial image. The mesh model of the reference face can explicitly represent external features of the reference face. A mesh parameter difference sequence is determined according to the to-be-converted content sequence. The mesh parameter difference sequence is used for indicating (e.g., identifying) differences between facial motion features indicated by the plurality of pieces of to-be-converted content, e.g., reflecting changes in the facial motion features of the original face over time during sound production. In an example, the mesh parameter difference sequence indicates changes of the facial motion features over time.

The server 120 adjusts the mesh model of the reference face by using the mesh parameter difference sequence, e.g., adjusts the mesh model of the reference face by using the facial motion features of the original face. Therefore, instead of using fixed facial contour parameters, dynamic adjustment is performed by using the facial motion features that change over time, so that in a facial mesh model sequence obtained through adjustment, the appearance features of the reference face are better fused with the facial motion features of the original face. The server 120 generates a target video according to the facial mesh model sequence and the reference facial image, thereby improving the quality of the target video.

The server 120 transmits the generated target video to the terminal device 110, so that the terminal device 110 displays the target video.

The video generation method provided in the aspects of this disclosure may be performed by a server. However, in other aspects of this disclosure, a terminal device may also have similar functions to the server, thereby performing the video generation method provided in the aspects of this disclosure, or the terminal device and the server jointly perform the video generation method provided in the aspects of this disclosure. This is not limited in this aspect.

In addition, the video generation method provided in this disclosure may be applied to various scenarios, including but not limited to, cloud technology, artificial intelligence, smart transportation, assisted driving, Internet of Things, and the like. Four scenarios are used as examples below.

### Scenario 1: Personalized video generation scenario.

When generating a personalized video, a user may provide a facial image (for example, a facial image of another person or a facial image of a virtual object) and a piece of audio or a video including audio by using the terminal device 110. The provided facial image is used as the reference facial image, the audio or the video is used as the to-be-converted content sequence, and the reference facial image and the to-be-converted content sequence are transmitted to the server 120 for processing. The server 120 generates a target video based on the video generation method provided in the aspects of this disclosure. In the target video, the facial image provided by the user can speak based on the audio, with accurate lip movements and coherent frames. In other words, the target video has high quality, and satisfies user demand for a personalized video.

### Scenario 2: Virtual object live streaming scenario.

Virtual objects may include non-real objects. When a virtual object is used for live streaming, a facial image of the virtual object and audio required for the upcoming live stream can be provided. The terminal device 110 uses the facial image of the virtual object as the reference facial image, uses the audio as the to-be-converted content sequence, and transmits the reference facial image and the to-be-converted content sequence to the server 120 for processing. The server 120 generates, based on the video generation method provided in the aspects of this disclosure, a target video for live streaming. In the target video, the virtual object can speak based on the audio, with accurate lip movements and coherent frames, and even the head motion trajectory of the virtual object matches the audio prosody. In other words, the target video has high quality, thereby improving a live streaming effect, and attracting audience.

### Scenario 3: Movie and television production.

When replacing an object A in a video (e.g., a completed video) with an object B, a facial image of the object B and a video clip of the object A may be provided. The terminal device 110 uses the facial image of the object B as the reference facial image, uses the video clip containing the object A as the to-be-converted content sequence, and transmits the reference facial image and the to-be-converted content sequence to the server 120 for processing. The server 120 generates a target video based on the video generation method provided in the aspects of this disclosure. Compared with the video clip containing the object A, in the target video, the object A is replaced with the object B. In some examples, in the target video, the object B replaces the object A to speak based on the audio, with accurate lip movements and coherent frames. In other words, the target video has high quality, satisfying user demand for video face swapping.

### Scenario 4: Gaming.

There may be a plurality of virtual objects in a game. The lip movements, head motion trajectory, and the like of a virtual object during speaking can be controlled using audio, thereby making the virtual object more vivid and improving the user experience. Using a singing game as an example, when a user sings in the singing game, a virtual object that is singing may be created for the user, and the user can specify a facial image of the virtual object, to match audio of the user during singing. The terminal device 110 uses the facial image of the virtual object as the reference facial image, uses the audio as the to-be-converted content sequence, and transmits the reference facial image and the to-be-converted content sequence to the server 120 for processing. The server 120 generates, based on the video generation method provided in the aspects of this disclosure, a target video in which the virtual object is singing. In the target video, the virtual object can speak based on the audio, with accurate lip movements and coherent frames, and even the head motion trajectory of the virtual object matches the audio prosody. In other words, the target video has high quality, thereby improving a game interaction effect, and attracting users to participate.

The video generation method provided in the aspects of this disclosure can be applied not only to personalized video generation but also to other scenarios requiring video synthesis, such as movies, games, and advertisements, and has broad application prospects. By using the video generation method provided in the aspects of this disclosure, a high-quality target video can be quickly generated, improving the user experience.

The following describes the video generation method provided in this disclosure in further detail through method aspects.

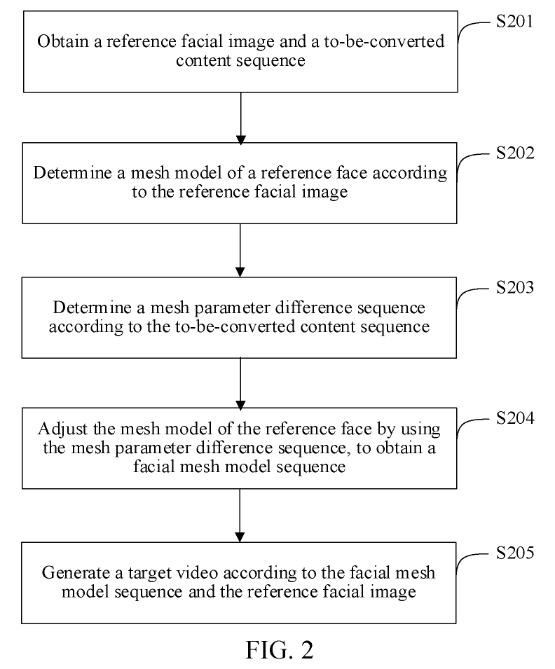

Referring to FIG. 2, FIG. 2 is a schematic flowchart of a video generation method according to an aspect of this disclosure. For ease of description, the following aspects are still described by using an example in which the video generation method is executed by a server. As shown in FIG. 2, the video generation method includes S201 to S205.

S201: Obtain a reference facial image and a to-be-converted content sequence.

The reference facial image includes appearance features of a reference face. The appearance features refer to features for describing the appearance of the reference face, such as facial contour features and hairstyle features, so that a target video in which the reference face is speaking can be generated based on the reference face subsequently. The face may be a human face, a face of an animal, a robot, a virtual human, or the like. This is not specifically limited in this disclosure.

The to-be-converted content sequence includes a plurality of pieces of to-be-converted content that change over time. In some examples, the plurality of pieces of to-be-converted content in the to-be-converted content sequence are arranged in a chronological order, such as a video (e.g., a video sequence) or an audio (e.g., an audio sequence) . A video includes a plurality of video frames that change over time, and an audio includes a plurality of sound waveforms that change over time.

The to-be-converted content not only provides audio required in the target video, but is also used for indicating facial motion features of the original face. The facial motion features are used for describing changes occurring in the original face during sound production, such as the expression and head motion trajectory, so that the plurality of pieces of to-be-converted content in the to-be-converted content sequence can be fused one by one into the reference facial image subsequently, thereby obtaining a target video in which the reference face speaks. In this way, during the speaking process of the reference face, the lip movements are consistent with the audio, and the head motion trajectory is consistent with the audio prosody, thereby improving the quality of the target video.

S202: Determine a mesh model of a reference face according to the reference facial image.

The mesh model of the reference face is a model of the reference face established based on a mesh, and can describe the appearance features of the reference face. In some examples, the mesh model of the reference face is a three-dimensional model. The three-dimensional model is formed by splicing polygons. Using triangular faces as an example, a complex polygon may be formed by stitching a plurality of triangular faces. Therefore, a surface of a three-dimensional model is formed by a plurality of triangular faces connected to each other. In a three-dimensional space, a set of points forming these triangular faces and edges of the triangles is the mesh.

The manner of obtaining the mesh model of the reference face is not specifically limited in this aspect of this disclosure, and may be set by a person skilled in the art according to applications including, for example, design parameters of the applications. One manner is described below as an example.

For example, key features such as edges, corners, and textures may be extracted from the reference facial image. Then, based on the extracted key features, a three-dimensional shape of the reference face is constructed by means of stereo vision, structured light, depth camera, and the like, to obtain a three-dimensional model of the reference face. Finally, after the three-dimensional model of the reference face is obtained, the surface of the three-dimensional model is discretized into a series of triangular faces to obtain the mesh model of the reference face.

S203: Determine a mesh parameter difference sequence according to the to-be-converted content sequence.

The to-be-converted content sequence includes a plurality of pieces of to-be-converted content that change over time, e.g., the plurality of pieces of to-be-converted content may have differences. Each piece of to-be-converted content is used for indicating facial motion features of an original face associated with the to-be-converted content sequence. Differences between the facial motion features indicated by two pieces of to-be-converted content can be determined based on the plurality of pieces of to-be-converted content included in the to-be-converted content sequence, thereby obtaining the mesh parameter difference sequence. Compared to mesh models of the original face included in each piece of to-be-converted content, in some examples, the mesh parameter difference sequence can indicate changes (e.g., more specifically reflect changes) occurring in the original face during sound production. In an example, the mesh parameter difference sequence indicates the changes of the facial motion features over time.

Assuming there are N pieces of to-be-converted content, any one of the N pieces of to-be-converted content, such as an i-th piece of to-be-converted content, may correspond to a difference in the mesh parameter difference sequence. For example, the difference may reflect a difference in facial motion features with respect to a j-th piece of to-be-converted content. Alternatively, the i-th piece of to-be-converted content may correspond to up to N-1 differences in the mesh parameter difference sequence. Assuming the i-th piece of to-be-converted content corresponds to two differences, the first difference reflects a difference in facial motion features with respect to the j-th piece of to-be-converted content, and the second difference reflects a difference in facial motion features with respect to a k-th piece of to-be-converted content.

The difference for each piece of to-be-converted content in the mesh parameter difference sequence may reflect differences in facial motion features between that to-be-converted content and other pieces of to-be-converted content in the N pieces of to-be-converted content. The entire mesh parameter difference sequence may reflect differences in facial motion features among different pieces of to-be-converted content.

In addition, since the facial motion features of each piece of to-be-converted content are characterized by differences, the features common to all pieces of to-be-converted content, namely, "facial contours of the original face", are weakened or even deleted from the mesh parameter difference sequence, so that the mesh parameter difference sequence can more accurately identify the time-varying facial motion features carried in the to-be-converted content sequence, without highlighting the facial contour features of the original face. In this way, when the mesh model of the reference face is subsequently adjusted by using the mesh parameter difference sequence, the facial contour features of the original face are not transferred to the mesh model of the reference face. As a result, in the finally generated target video, the facial contours that exhibit the facial motion features identified by the to-be-converted content sequence better conform to the reference face, without resembling the original face.

In an example, the mesh parameter difference sequence includes a plurality of mesh parameter differences, and the quantity of the mesh parameter differences is consistent with the quantity of pieces of to-be-converted content, e.g., there is a one-to-one mapping between the plurality of pieces of to-be-converted content and the mesh parameter differences. Each mesh parameter difference is used for identifying a difference between the mesh model corresponding to an original face included in the current piece of to-be-converted content and a standard mesh model. The standard mesh model is a mesh model corresponding to an original face included in one piece of to-be-converted content in the to-be-converted content sequence. For example, an original face whose expression is most similar to that of the reference face may be selected from a plurality of original faces included in the to-be-converted content sequence, and the mesh model of the selected original face may be used as the standard mesh model. For another example, a mesh model corresponding to an original face included in a preceding piece of to-be-converted content may be used as the standard mesh model for a mesh model corresponding to an original face included in a succeeding piece of to-be-converted content. This is not limited in this disclosure, and may be set by a person skilled in the art according to applications including, for example, design parameters of the applications.

The method of obtaining the mesh parameter difference sequence is not specifically limited in this aspect of this disclosure. Three methods are described below as examples.

Method 1: Conversion is performed according to the to-be-converted content sequence by using an audio-to-mesh-sequence model, to obtain the mesh parameter difference sequence.

In some examples, an audio-to-mesh-sequence model is trained. The audio-to-mesh-sequence model can establish a mapping relationship between a to-be-converted content sequence and a mesh parameter difference sequence. For example, the to-be-converted content is audio, and the audio may include an audio prosody of an original face that produces the audio. For instance, if the sound in the audio is consistently calm, the original face may remain still. For another example, if the sound in the audio gradually becomes quieter, the facial motions of the original face may gradually become smaller. A corresponding mesh parameter difference sequence is generated based on the to-be-converted content sequence.

A training process of the audio-to-mesh-sequence model is described below.

A talking head video sample having a first label is obtained. The first label is used for identifying a mesh parameter difference sequence corresponding to an original face sample in the talking head video sample. For example, a video frame may be selected from the talking head video sample, and a mesh model of an original face sample included in the video frame may be used as a standard mesh model. Then, a difference between a mesh model of an original face sample included in each video frame and the standard mesh model is calculated, to obtain a mesh parameter difference for each video frame, thereby obtaining a mesh parameter difference sequence corresponding to the original face sample, e.g., the first label.

According to the talking head video sample, conversion is performed using the initial audio-to-mesh-sequence model to obtain a predicted mesh parameter difference sequence. Model parameters of the initial audio-to-mesh-sequence model are adjusted according to a difference between the predicted mesh parameter difference sequence and the first label, so that the predicted mesh parameter difference sequence becomes closer to the first label, thereby obtaining the audio-to-mesh-sequence model.

The audio-to-mesh-sequence model is not specifically limited in this aspect of this disclosure, and may be based on a Wav2vec model (an unsupervised pre-training model for speech recognition) or the like.

Method 2: Conversion is performed according to the to-be-converted content sequence by using an audio-to-mesh model, to obtain a mesh model of each piece of to-be-converted content in the to-be-converted content sequence. A standard mesh model is determined from the plurality of mesh models. Differences between the plurality of mesh models and the standard mesh model are calculated, to obtain a mesh parameter for each piece of to-be-converted content, thereby obtaining the mesh parameter difference sequence.

A training process of the audio-to-mesh model is described below.

A talking head image sample having a second label is obtained. The second label includes a plurality of mesh models used for identifying the talking head image sample. Conversion is performed according to the talking head image sample by using an initial audio-to-mesh model, to obtain a plurality of predicted mesh models included in the talking head image sample. Model parameters of the initial audio-to-mesh model are adjusted according to differences between the plurality of predicted mesh models and the second label, so that the predicted mesh models become closer to the second label, thereby obtaining the audio-to-mesh model.

Method 3: A mesh model of the original face in each piece of to-be-converted content is determined according to the to-be-converted content sequence. A standard mesh model is determined from the plurality of mesh models of the original face, and differences between the plurality of mesh models of the original face and the standard mesh model are calculated to obtain a mesh parameter difference for each piece of to-be-converted content, thereby obtaining the mesh parameter difference sequence.

If the to-be-converted content is a video, and the video includes images of the original face, the mesh model may be directly obtained based on the video. In this case, method 3 is more suitable for obtaining the mesh parameter difference sequence. If the to-be-converted content is audio, and the audio does not include images of the original face, the mesh model may not be directly obtained. In this case, method 1 or method 2 is more suitable.

In addition, this aspect of this disclosure does not limit the manner of determining the standard mesh model. The standard mesh model may be selected in various manners, or selected according to similarity to the reference facial image, or selected in a default manner. The determining manner will be described in further detail subsequently and is not repeated herein.

S204: Adjust the mesh model of the reference face by using the mesh parameter difference sequence to obtain a facial mesh model sequence. In an example, the mesh model of the reference face is adjusted based on the mesh parameter difference sequence to obtain the facial mesh model sequence.

In related technologies, a mesh model for generating a target video is directly extracted from a to-be-converted content sequence. However, facial contours of a face in the target video generated based on the mesh model is relatively similar to facial contours of the original face in the to-be-converted content. If the reference face is significantly different from the original face, the face in the target video may exhibit an appearance consistent with the reference facial image but facial contours consistent with the original face. Consequently, the face in the target video is not similar to the reference face, e.g., the target video has poor quality.

In addition, in a two-dimensional image, an object only has two dimensions, namely, length and width. In a three-dimensional space, an object has an additional dimension, namely, depth. Therefore, when an attempt is made to map a two-dimensional object to a three-dimensional space, there are a plurality of possible mapping manners, and each manner corresponds to a different position and form in the three-dimensional space. A circle on a two-dimensional image is used as an example. When mapped to the three-dimensional space, the circle may be presented in a plurality of manners. The circle may be presented as a circle on a plane, a three-dimensional sphere or cylinder, or even a distorted, irregular three-dimensional shape.

In some examples, the to-be-converted content includes audio (e.g., an audio sequence) or a video (e.g., a video sequence), and the original face included in the to-be-converted content may be displayed as a two-dimensional image. In some examples, the to-be-converted content includes the audio sequence. In some examples, the to-be-converted content includes the video sequence. In some examples, the mesh parameter difference sequence is obtained based on a mesh model, and the mesh model is located in a three-dimensional space, e.g., involving the issue of mapping a two-dimensional object to a three-dimensional space. Therefore, there are a plurality of mapping manners. Although the audio does not directly display an original face as a two-dimensional image, the audio is trained based on two-dimensional images including the audio, to discover a mapping relationship between the audio and the original face in the two-dimensional images, e.g., the audio can imply the two-dimensional image of the original face.

In other words, if the mesh model is directly obtained according to the to-be-converted content sequence, and then the target video is generated based on the mesh model, the face in the target video is greatly affected by the original face. In addition, due to a plurality of mapping manners, the face in the target video may appear to fluctuate in size, leading to low quality of the target video.

Based on this, in this disclosure, the model extracted from the to-be-converted content sequence is not directly used; instead, the mesh model of the reference face is fused with differences between models, e.g., the mesh model of the reference face is adjusted based on the mesh parameter difference sequence to obtain a facial mesh model sequence. The facial mesh model sequence includes a plurality of facial mesh models, and each facial mesh model is obtained by adjusting the mesh model of the reference face based on a mesh parameter difference. The quantity of facial mesh models in the facial mesh model sequence is the same as the quantity of pieces of to-be-converted content included in the to-be-converted content sequence.

In some examples, the mesh parameter difference sequence can reflect changes in the original face during sound production, such as expression changes and head motion trajectory changes. The mesh model of the reference face is used for reflecting the appearance of the reference face, such as facial contours and hairstyle. Therefore, by adjusting the mesh model of the reference face based on the mesh parameter difference sequence, for example, by directly performing mesh parameter superposition calculation, the changes in the original face during sound production can be incorporated into the reference face while keeping the appearance of the reference face unchanged, thereby obtaining a facial mesh model sequence. The facial mesh model sequence is equivalent to a fusion result between changes in the facial motion features of the original face during sound production and the appearance features of the reference face. The fusion result is not static, thereby improving the quality of the subsequently generated target video.

S205: Generate a target video according to the facial mesh model sequence and the reference facial image.

The facial mesh model sequence can reflect facial feature changes, such as appearance and expression. The reference facial image can provide a texture feature, an age feature, a color feature, and the like. Therefore, a plurality of video frames can be obtained based on the facial mesh model sequence and the reference facial image. Each video frame is obtained based on a facial mesh model in the facial mesh model sequence and the reference facial image. Further, the target video is obtained based on the plurality of video frames.

A face appearing in the target video is the reference face identified by the reference facial image. In the target video, the reference face performs the facial motion features of the to-be-converted content based on time-varying characteristics identified in the to-be-converted content sequence.

The target video may further include audio, e.g., the target video is synthesized based on the plurality of video frames and the audio. In this way, in the target video, sound is produced based on the appearance of the reference facial image, and facial motions of the reference facial image during sound production are consistent with the to-be-converted content sequence, for example, lip movements are consistent with the audio, expressions are consistent with the audio, and a head motion trajectory is consistent with the audio prosody, thereby improving the quality of the target video.

As can be seen from the foregoing technical solutions, a reference facial image and a to-be-converted content sequence are obtained. The reference facial image includes appearance features of a reference face. The to-be-converted content sequence includes a plurality of pieces of to-be-converted content that change over time, and each piece of to-be-converted content indicates facial motion features of an original face. A mesh model of the reference face is determined according to the reference facial image. The mesh model of the reference face can explicitly represent external features of the reference face. A mesh parameter difference sequence is determined according to the to-be-converted content sequence. The mesh parameter difference sequence is used for identifying differences between facial motion features indicated by the plurality of pieces of to-be-converted content, e.g., reflecting changes in the facial motion features of the original face over time during sound production. The mesh model of the reference face is adjusted by using the mesh parameter difference sequence, e.g., the mesh model of the reference face is adjusted by using the facial motion features of the original face. Therefore, instead of using fixed facial contour parameters, dynamic adjustment is performed by using the facial motion features that change over time, so that in a facial mesh model sequence obtained through adjustment, the appearance features of the reference face are better fused with the facial motion features of the original face. A target video is generated according to the facial mesh model sequence and the reference facial image, thereby improving the quality of the target video.

It can be learned from the foregoing description that the selection of the standard mesh model is not specifically limited in this aspect of this disclosure, and three methods are described below as examples.

Method 1: A mesh model with a similar expression is selected, as described in A1-A4 as an example.

A1: Determine a mesh model sequence of the original face according to the to-be-converted content sequence.

The mesh model sequence of the original face includes a plurality of mesh models of the original face, and the quantity of the mesh models of the original face is the same as the quantity of pieces of to-be-converted content included in the to-be-converted content sequence. For example, if the to-be-converted content sequence is a video, each mesh model of the original face may be obtained in a manner similar to obtaining the mesh model of the reference face. Details are not described herein again. For another example, if the to-be-converted content is audio, conversion may be performed by using the audio-to-mesh model described above, to obtain a mesh model for each piece of to-be-converted content.

A2: Determine similarities between the plurality of mesh models of the original face and the mesh model of the reference face. In an example, a similarity between each of the plurality of mesh models of the original face and the mesh model of the reference face is determined.

The similarity may refer to a degree of similarity between two mesh models, and a manner of determining the similarity is not limited in this aspect of this disclosure. For example, mesh models may be converted to point clouds, and then a distance metric between two point clouds may be calculated to determine the similarity. For another example, features of mesh models, such as volume, surface area, and curvature, may be extracted, and the similarity may be determined based on differences between the features of two mesh models.

In an example, since the facial motion features of the original face are to be fused into the reference face, the expression of the mesh model of the original face and the expression of the mesh model of the reference face may be determined, to determine a similarity between the two mesh models. Expressions may be determined by using features, expression weight coefficients, and the like, so that only the expression of the mesh model is calculated. This not only reduces the amount of computation but also provides targeted expression calculation, thereby improving the accuracy of subsequent fusion, and improving the quality of the target video.

A3: Determine, among the plurality of mesh models of the original face, a mesh model whose similarity meets a similarity condition as a standard mesh model. In an example, the mesh model (e.g., the standard mesh model) whose similarity meets the similarity condition is determined among the plurality of mesh models of the original face and according to the determined similarities.

In the mesh model sequence of the original face, a mesh model that meets the similarity condition is determined as the standard mesh model, e.g., the standard mesh model is relatively similar to the mesh model of the reference face. The similarity condition is not limited in this aspect of this disclosure. For example, the similarity condition may be a highest degree of similarity.

A4: Obtain the mesh parameter difference sequence according to differences in facial motion features between each mesh model in the mesh model sequence of the original face and the standard mesh model. In an example, the mesh parameter difference sequence is obtained according to a difference between each mesh model in the mesh model sequence of the original face and the standard mesh model.

Using the standard mesh model having a relatively high similarity with the mesh model of the reference face as a basis, a difference in facial motion features between each mesh model of the original face and the standard mesh model is calculated, to obtain a mesh parameter difference sequence including a plurality of differences. This is equivalent to obtaining a difference between each mesh model of the original face and the mesh model of the reference face. Therefore, subsequent adjustment of the mesh model of the reference face based on the mesh parameter difference sequence is more accurate, convenient, and efficient. In addition, in this method, the reference facial image is not limited. In other words, the user can select the reference facial image in various manners, thereby improving user experience.

Method 2: With an expression of the reference face limited to a first state, a mesh model conforming to the first state is selected, as described in B1-B3 as an example.

B1: Determine a mesh model sequence of the original face according to the to-be-converted content sequence.

The mesh model sequence of the original face includes a plurality of mesh models of the original face.

B2: Determine, among the plurality of mesh models of the original face, a mesh model whose expression conforms to the first state as a standard mesh model.

In this aspect, the expression of the reference face in the reference facial image is in the first state. In an example, the first state is a neutral expression state. Superimposing the expression of the original face onto the reference facial image in the neutral expression state yields a better effect, and the subsequently obtained target video has higher quality.

In the mesh model sequence of the original face, a mesh model whose expression conforms to the first state is determined as the standard mesh model, which is equivalent to selecting a mesh model that is relatively similar to the reference face from the mesh model sequence of the original face as the standard mesh model.

B3: Obtain the mesh parameter difference sequence according to differences in facial motion features between each mesh model in the mesh model sequence of the original face and the standard mesh model.

If the first state is the neutral expression state, each difference in the mesh parameter difference sequence is a difference between the mesh model of each original face and the standard mesh model in the neutral expression state, so that it is easier to adjust the mesh model of the reference facial image, which is also in the neutral expression state, based on the mesh parameter difference sequence, thereby improving the accuracy of the subsequent target video.

After the expression of the reference face is limited to the first state, a mesh model that conforms to the first state may be directly selected from the mesh model sequence of the original face as the standard mesh model. This is equivalent to selecting a mesh model relatively similar to the mesh model of the reference face from the plurality of mesh models. This method not only has the advantages of the foregoing method 1 (A1 to A4), but also improves the quality of the subsequent target video without performing similarity calculation, thereby reducing the amount of computation, shortening the generation time of the target video, and improving user experience.

Method 3: Without limiting the expression of the reference face to the first state, a mesh model conforming to the first state is selected, as described in C1-C5 as an example.

C1: Obtain a candidate reference facial image.

The candidate reference facial image is an image specified by a user. It is desired to generate a video in which a face included in the candidate reference facial image speaks. Compared with the reference facial image in method 2 (B1 to B3), an expression state of the face included in the candidate reference facial image is not limited in this aspect. For example, an expression of a reference face in the candidate reference facial image may be in a second state, e.g., the expression of the reference face specified by the user is not limited.

C2: Adjust facial motion features of a reference face in the candidate reference facial image based on a first state, to obtain a reference facial image.

The facial motion features of the reference face in the candidate reference facial image are adjusted, so that the reference face changes from the second state to the first state, to obtain the reference facial image.

An adjustment manner is not limited in this aspect of this disclosure. For example, a diffusion model may be used. The diffusion model can generate various states of a face, for example, generate a smiling state based on a neutral expression state, so that an image in which a facial expression is the first state, e.g., the reference facial image, can be obtained by using the diffusion model based on the candidate reference facial image in which the facial expression is the second state.

C3: Determine a mesh model sequence of the original face according to the to-be-converted content sequence.

C4: Determine, in the mesh model sequence of the original face, a mesh model whose expression conforms to the first state as a standard mesh model.

C5: Obtain the mesh parameter difference sequence according to a difference between each mesh model in the mesh model sequence of the original face and the standard mesh model.

For C3 to C5, refer to the foregoing B1 to B3, and details are not described herein again.

When the expression is not limited to the first state, the expression can be adjusted from the second state to the first state, e.g., the reference facial image is obtained based on the candidate reference facial image. Then, a mesh model conforming to the first state may be directly selected from the mesh model sequence of the original face as the standard mesh model. This is equivalent to selecting a mesh model relatively similar to the mesh model of the reference face from the plurality of mesh models. Method 3 not only has the advantage of the foregoing method 2 (B1 to B3), but also does not limit the expression state, thereby expanding application scenarios and improving user experience.

In an implementation, this aspect of this disclosure further provides an implementation of S205 as an example, e.g., an implementation of generating a target video according to the facial mesh model sequence and the reference facial image. In some examples, the facial mesh model sequence may be reprojected first, to obtain a facial pose sequence. Then, the target video is generated according to the facial pose sequence and the reference facial image.

The facial pose sequence includes a plurality of facial poses, and each facial pose is obtained by reprojecting a facial mesh model. Using one facial mesh model in the facial mesh model sequence as an example, the facial mesh model may be reprojected to obtain a corresponding facial pose, thereby obtaining the facial pose sequence.

The reprojection may refer to generating a new image, e.g., a facial pose image, by projecting a facial mesh model from any viewpoint. Reprojection can help ensure accurate mapping of a three-dimensional structure of a face onto a two-dimensional image, thereby enabling more precise acquisition of key facial feature points and contour information, and more accurate description of facial poses (such as rotation angles and offsets).

In addition, the facial mesh model is a three-dimensional model, while the facial pose is a two-dimensional image. After the three-dimensional model is converted into a two-dimensional image, it is easier to generate a corresponding video frame according to the facial pose and the reference facial image that are both two-dimensional images. The target video is generated according to the facial pose sequence and the reference facial image, so that the obtained target video has higher quality. In addition, facial pose data is more efficient in terms of representation than mesh model data. In other words, there are fewer facial pose parameters, and calculation costs are relatively low. This helps accelerate a processing speed and reduce hardware requirements.

The three-dimensional facial mesh model is first converted into the two-dimensional facial pose through reprojection, thereby ensuring geometric accuracy of the face and reducing the amount of computation. Then, the target video is obtained based on the facial poses in the facial pose sequence and the appearance features of the reference facial image, thereby improving the generation efficiency and quality of the target video.

During the process of speaking, not only the expression of the face changes, but the head also changes. For example, the head may nod or turn in the speaking process, e.g., the head changes with the prosody of the audio. To improve the quality of the target video, in some examples, a head motion trajectory is considered.

Case 1: If the to-be-converted content sequence is a video, since the video directly includes a facial image, the mesh parameter difference sequence obtained based on the video can reflect not only expression changes but also head motion trajectory changes. Therefore, in the obtained target video, the head motion trajectory will change based on the prosody of the audio.

Case 2: In various examples, audio does not directly include a facial image. If the to-be-converted content sequence is audio, prediction may be performed based on the audio. In some examples, to improve prediction accuracy, both the expression and head motion trajectory may be predicted based on the audio. It can be known from the foregoing description that the mesh parameter difference sequence may be obtained from the to-be-converted content sequence by using an audio-to-mesh-sequence model or an audio-to-mesh model.

Using the audio-to-mesh-sequence model as an example, conversion may be performed according to the to-be-converted content sequence by using the audio-to-mesh-sequence model, to obtain the mesh parameter difference sequence. However, if the mesh parameter differences included in the mesh parameter difference sequence reflect not only expression changes but also head motion trajectory changes, the mesh parameter differences may not converge in a process of training the audio-to-mesh-sequence model, making it impossible to complete the training.

It has been found through research that, predicting expression changes and predicting head motion trajectory changes are two prediction tasks. If the two prediction tasks are performed based on the same model, the model may fail to focus on learning, causing non-convergence.

Therefore, in this aspect of this disclosure, two prediction tasks are separated. In some examples, the mesh parameter difference sequence is determined according to the to-be-converted content sequence. The mesh parameter difference sequence is used for identifying differences between expressions indicated by the plurality of pieces of to-be-converted content, so that the expression prediction task is accomplished. A head pose vector sequence is determined according to the to-be-converted content sequence. The head pose vector sequence includes a plurality of pose vectors, and each pose vector is used for describing a position of the head, an orientation of the head, and the like, to reflect changes in the head motion trajectory, thereby accomplishing the head motion trajectory prediction task. Finally, a facial mesh model sequence is obtained according to the mesh parameter difference sequence, and the facial mesh model sequence and the head pose vector sequence are reprojected to obtain a facial pose sequence.

The method of obtaining the head pose vector sequence is not specifically limited in this aspect of this disclosure. Two methods are described below as examples.

Method 1: Conversion is performed according to the to-be-converted content sequence by using an audio-to-pose-sequence model, to obtain the head pose vector sequence.

In some examples, the audio-to-pose-sequence model is trained. The audio-to-pose-sequence model can establish a mapping relationship between the to-be-converted content sequence and the head pose vector sequence, thereby generating the corresponding mesh parameter difference sequence based on the to-be-converted content sequence.

A training process of the audio-to-pose-sequence model is described below.

A talking head video sample having a third label is obtained. The third label is used for identifying a head pose vector sequence corresponding to an original face sample in the talking head video sample. According to the talking head video sample, conversion is performed by using an initial audio-to-pose-sequence model, to obtain a predicted head pose vector sequence. Model parameters of the initial audio-to-pose-sequence model are adjusted according to a difference between the predicted head pose vector sequence and the third label, so that the predicted head pose vector sequence becomes closer to the third label, thereby obtaining the audio-to-pose-sequence model.

The audio-to-pose-sequence model is not specifically limited in this aspect of the present disclosure, and may be based on a Wav2vec model or the like.

Method 2: Conversion is performed according to the to-be-converted content sequence by using an audio-to-pose model, to obtain a head pose vector of each piece of to-be-converted content in the to-be-converted content sequence, thereby obtaining the head pose vector sequence based on a plurality of head pose vectors.

A training process of the audio-to-pose model is described below.

A talking head image sample having a fourth label is obtained. The fourth label is used for identifying head pose vectors of a plurality of talking head image samples. According to the talking head image sample, conversion is performed by an initial audio-to-pose model, to obtain a plurality of predicted head pose vectors corresponding to the talking head image sample. Model parameters of the initial audio-to-pose model are adjusted according to a difference between the plurality of predicted head pose vectors and the fourth label, so that the predicted head pose vectors become closer to the fourth label, thereby obtaining the audio-to-pose model.

If the to-be-converted content sequence is audio, the expression prediction task and the head motion trajectory prediction task can be separated. For example, the mesh parameter difference sequence may be obtained according to the to-be-converted content sequence by using the audio-to-mesh-sequence model, and the head pose vector sequence may be obtained according to the to-be-converted content sequence by using the audio-to-pose-sequence model. This allows each prediction task to be more targeted, improves prediction accuracy, and thereby improves the quality of the target video.

In an implementation, this aspect of this disclosure further provides an implementation of S205 as an example, e.g., an implementation of generating a target video according to the facial mesh model sequence and the reference facial image. For details, refer to S2051 to S2053.

S2051: Perform feature extraction on the reference facial image to obtain image features of the reference facial image.

The image features are used for describing characteristics of the reference facial image, such as a texture feature, an identity feature, and a color feature of the reference facial image, so that the characteristics of the reference facial image are learned again, making the subsequently generated target video more similar to the reference facial image.

In an example, since the size of the reference facial image is relatively large, and the generated target video requires computation on data superimposed over a plurality of frames, to reduce the amount of computation, the amount of data may be reduced by encoding. In some examples, the reference facial image is encoded to obtain a reference facial image code. A data dimension of the reference facial image code is less than a data dimension of the reference facial image, so as to reduce the feature dimension. For example, the reference facial image having a size of 3 × 512 × 512 may be mapped to a low-dimensional feature of 4 × 64 × 64. Subsequently, feature extraction may be performed on the reference facial image code, to obtain the image features of the reference facial image.

An encoding method is not specifically limited in this aspect of this disclosure. For example, encoding may be performed by using a variational autoencoder (VAE) encoder.

S2052: Perform feature extraction on the facial mesh model sequence to obtain a facial feature sequence.

The facial feature sequence includes facial features required for a plurality of video frames. The facial features are obtained by adjusting the mesh model of the reference face based on the mesh parameter difference sequence. For example, the facial contours of the reference face may be fused with the expressions of the original face, thereby reflecting characteristics of a fused face.

In an example, facial features, such as key point positions on the face, changes in the motions of facial components, and expression weight coefficients, may be extracted from the facial feature sequence by using a pose guide, thereby more accurately describing the characteristics of the face.

S2053: Generate the target video according to the image features and the facial feature sequence.

Each facial feature included in the facial feature sequence is fused with the image features to obtain a plurality of video frames, thereby obtaining the target video.

In an example, if the image features are obtained by encoding the reference facial image, video generation may be performed according to the image features and the facial feature sequence, to obtain a target video code, and the target video code can be decoded to obtain the target video. For example, if a VAE encoder is used for encoding, a VAE decoder corresponding to the VAE encoder can be used for decoding.

Image features are extracted from the reference facial image, a facial feature sequence is extracted from the facial mesh model, and the image features and the facial feature sequence are fused to obtain the target video. This is equivalent to learning the appearance features of the reference face in the reference facial image first, and then learning the image features of the reference facial image, e.g., learning the reference facial image incrementally over a plurality of times, so that the style of the target video is more similar to that of the reference facial image, thereby improving the quality of the target video.

In an implementation, this aspect of this disclosure further provides an implementation of S2051 as an example, e.g., an implementation of performing feature extraction according to the reference facial image to obtain image features of the reference facial image. For details, refer to D1-D5.

D1: Obtain a noise vector for a facial feature in the facial feature sequence.

For ease of description, a target facial feature in the plurality of facial features included in the facial feature sequence is used as an example for description below. In a process of obtaining a corresponding video frame for a target face, e.g., a target video frame, a noise vector, such as a vector corresponding to Gaussian noise, can be obtained.

D2: Perform convolution calculation according to the noise vector by using a convolutional layer included in the diffusion model, to obtain shallow features.

In this aspect of this disclosure, the diffusion model may include a convolutional layer, a cross-attention layer, and a stereo cross-attention layer that are stacked together. The convolutional layer is not specifically limited in this aspect of this disclosure. For example, a residual neural network (ResNet) may be used. According to the noise vector, convolution calculation is performed using the convolutional layer included in the diffusion model to obtain shallow features. The shallow features are used for describing some detailed content.

D3: Perform feature fusion according to the shallow features and the facial feature by using a cross-attention layer included in the diffusion model, to obtain deep features.

The target facial feature is superposed on the shallow features to achieve injection of pose guidance information, thereby obtain deep features. The deep features can capture complex structures and patterns of data, thereby improving recognition accuracy and a generalization capability.

D4: Perform feature fusion according to the deep features and the image features by using a stereo cross-attention layer included in the diffusion model, to obtain a video frame in the target video.

The image features of the reference facial image are superimposed on the deep features to achieve injection of information of the reference facial image, thereby combining the noise vector, the target facial feature, and the image features to obtain the target video frame corresponding to the target facial feature.

After the noise vector is introduced, a target video frame that is expected to be outputted may be obtained through a plurality of cycles of a denoising process.

D5: Generate the target video from video frames respectively obtained by using facial features included in the facial feature sequence.

The facial features included in the facial feature sequence are respectively used as target facial features to obtain video frames corresponding to the facial features, thereby obtaining the target video based on the plurality of video frames.

By introducing the noise vector, the subsequent diffusion model may produce subtle variations when generating target video frames, so that each generated video frame is different, thereby enriching details of the target video. This avoids the generation of repetitive or overly regular images during the generation process, thereby improving the quality of the target video. In addition, the noise vector also helps the diffusion model to better capture details and textures in data, making the generated video frames more realistic and natural, and the frames more coherent.

For ease of further understanding the technical solutions provided in the aspects of this disclosure, the following example describes the video generation method as a whole by using an example in which the video generation method provided in the aspects of this disclosure is executed by a server.

First, the usage process of the video generation method is described below.

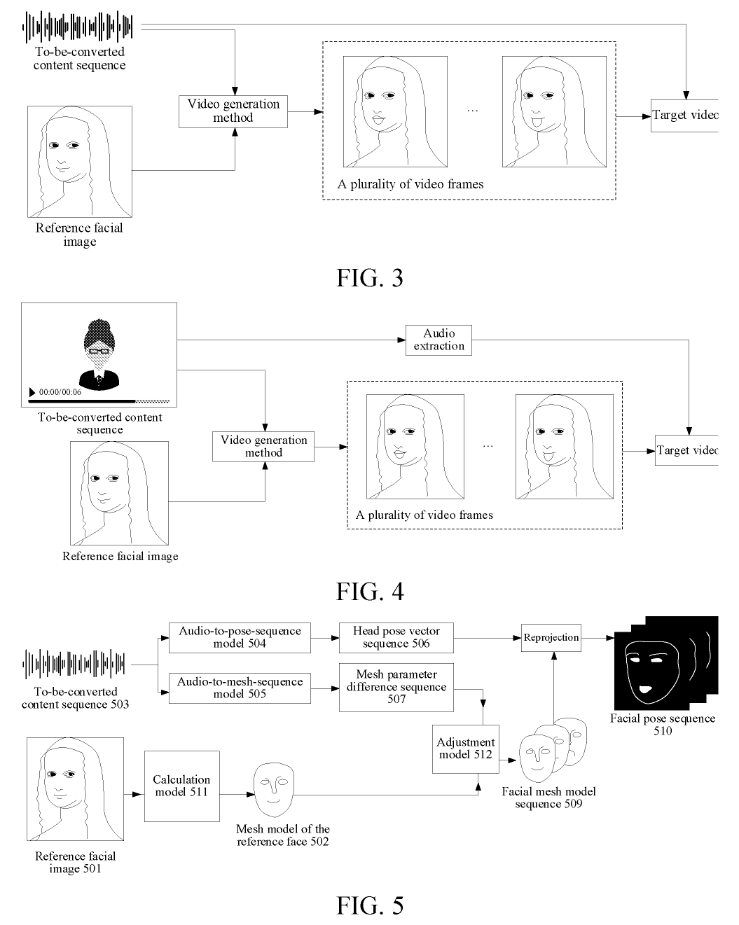

A user may upload a to-be-converted content sequence, and the user may specify a reference image, for example, upload a reference image or select one candidate reference image from a plurality of candidate reference images for use. This is not specifically limited in this disclosure. Depending on different to-be-converted content sequences uploaded by the user, there are two implementations, as shown in FIG. 3 and FIG. 4 respectively, and the two implementations are described separately below.

If the to-be-converted content sequence is audio, processing is performed based on the manner in FIG. 3. In some examples, after the audio and the reference facial image are obtained, the audio uploaded by the user is used as the to-be-converted content. A plurality of video frames are obtained by using the video generation method provided in this aspect of this disclosure, and the quantity of the plurality of video frames matches a length of the audio. Finally, the plurality of video frames are synthesized with the audio to obtain a target video.

If the to-be-converted content sequence is a video, processing is performed based on the manner in FIG. 4. In some examples, the video uploaded by the user is used as the to-be-converted content, and a plurality of video frames are obtained by using the video generation method provided in this aspect of this disclosure. Finally, audio is extracted from the video, and the plurality of video frames are synthesized with the audio to obtain a target video. The process of extracting the audio from the video and then synthesizing the audio with the plurality of video frames to obtain the target video also falls within the video generation method provided in this aspect of this disclosure.

Next, description is made from the perspective of a video generation system.

The video generation system includes three models, namely, an audio conversion module, a video conversion module, and a video generation module. The three modules are separately described below.

### 1 Audio conversion module

When it is recognized that the to-be-converted content is audio, a facial pose sequence is obtained by using the audio conversion module. Referring to FIG. 5, FIG. 5 is a schematic diagram of an audio conversion module according to an aspect of this disclosure.

A mesh model 502 of a reference face is obtained based on a reference facial image 501. In an example, a calculating model 511 is configured to determine the mesh model 502. The mesh model 502 of the reference face may include facial contour information of the reference face. In addition, in a scenario where the to-be-converted content sequence 503 includes the audio (also referred to as the audio sequence), an expression of the reference facial image 501 may be a neutral expression image. If the expression of the reference facial image 501 is another expression, a neutral expression reference facial image may be generated by using a diffusion model, so as to more conveniently obtain a facial mesh model sequence subsequently.

The audio (e.g., the audio sequence) is divided into a plurality of audio segments according to a duration of the audio. For example, the audio may be divided into a plurality of audio segments in a format of 30 frames per second (fps), so as to obtain a facial pose based on each audio segment. The plurality of audio segments are inputted into an audio-to-pose-sequence model 504, and conversion is performed by using the audio-to-pose-sequence model 504 to obtain a head pose vector sequence 506, thereby reflecting a head motion trajectory matching the audio. The plurality of audio segments are inputted into an audio-to-mesh-sequence model 505, and conversion is performed by using the audio-to-mesh-sequence model 505, to obtain a mesh parameter difference sequence 507, thereby reflecting changes such as lip movements and blinking actions of the original face during sound production.

The mesh model 502 of the reference face is adjusted by using the mesh parameter difference sequence 507, to obtain a facial mesh model sequence 509. In an example, an adjustment model 512 is configured to adjust the mesh model 502 with the mesh parameter difference sequence 507. For example, pieces of information from the mesh parameter difference sequence 507 and the mesh model 502 are combined to determine the facial mesh model sequence 509. Reprojection is performed according to the facial mesh model sequence 509 and the head pose vector sequence 506, to obtain a facial pose sequence 510. The facial pose sequence 510 may be a planar facial pose sequence that produces the audio.

### 2 Video conversion module

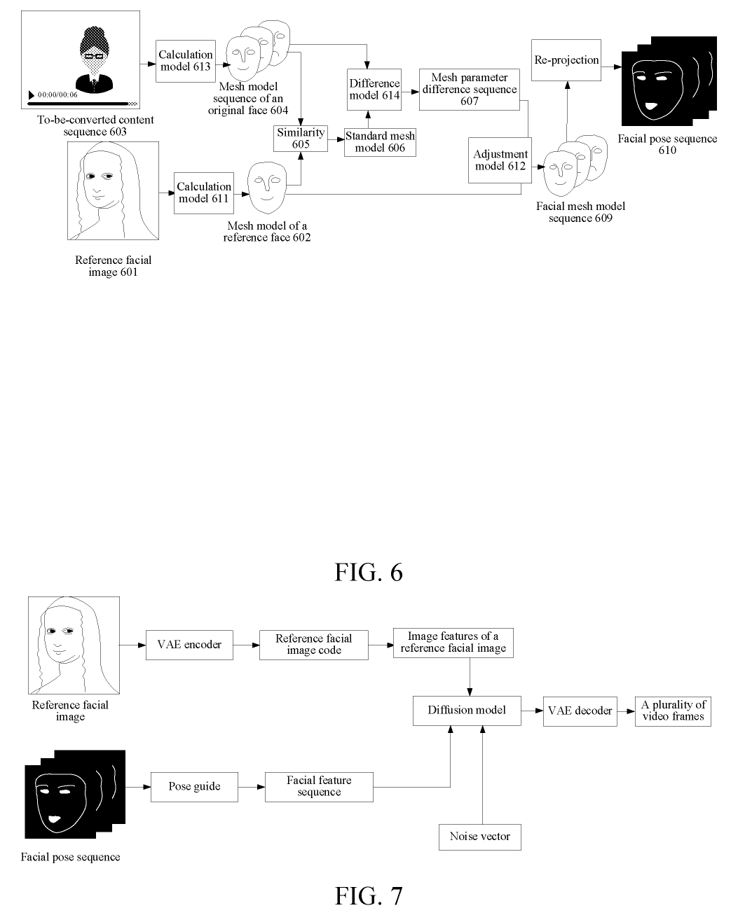

When it is recognized that the to-be-converted content is a video, the video conversion module is used to obtain a facial pose sequence. Referring to FIG. 6, FIG. 6 is a schematic diagram of a video conversion module according to an aspect of this disclosure.

A mesh model 602 of a reference face is obtained based on a reference facial image 601. In addition, in a scenario in which the to-be-converted content sequence 603 includes the video (also referred to as the video sequence), an expression of the reference facial image 601 may be any expression. Based on each video frame included in the video, a mesh model of the original face in each video frame is obtained, thereby obtaining a mesh model sequence 604 of the original face.

Similarities between the plurality of mesh models of the original face in the mesh model sequence 604 and the mesh model 602 of the reference face are determined, for example, in a similarity model 605. In an example, each similarity between the respective one of the plurality of mesh models of the original face and the mesh model of the reference face is separately determined. According to the similarities between the plurality of mesh models of the original face and the mesh model of the reference face, a mesh model 606 that meets a similarity condition is determined in the mesh model sequence 604 of the original face to serve as a standard mesh model 606. A mesh parameter difference sequence 607 is obtained according to differences between each mesh model in the mesh model sequence 604 of the original face and the standard mesh model 606, for example, using a difference model 614.

The mesh model 602 of the reference face is adjusted by using the mesh parameter difference sequence 607 to obtain a facial mesh model sequence 609, e.g., facial contour transformation is implemented. In an example, an adjustment model 612 is configured to adjust the mesh model 602 with the mesh parameter difference sequence 607. For example, pieces of information from the mesh parameter difference sequence 607 and the mesh model 602 are combined to determine the facial mesh model sequence 609. In an example, the facial mesh model sequence 609 includes a head pose vector sequence. Reprojection may be performed (e.g., directly performed) based on the facial mesh model sequence 609 to obtain a facial pose sequence 610.

### 3 Video generation module

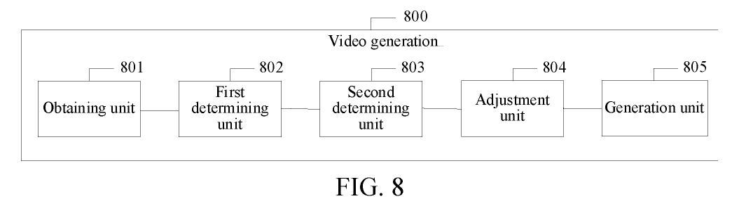

Referring to FIG. 7, FIG. 7 is a schematic diagram of a video generation module according to an aspect of this disclosure. It can be known from the foregoing description that both the video conversion module and the audio conversion module obtain a corresponding facial pose sequence. The facial pose sequence is inputted to a pose guide. The pose guide extracts facial poses to obtain a facial feature sequence, e.g., evolving the facial pose sequence into a coherent image sequence of corresponding actions, and the facial feature sequence is inputted to the diffusion model.

The reference facial image is inputted to a VAE encoder, and encoding is performed by using the VAE encoder to obtain a reference facial image code. Then feature extraction is performed on the reference facial image code to obtain image features of the reference facial image, and the image features of the reference facial image are inputted to the diffusion model.

The diffusion model obtains a video code according to the facial feature sequence, the image features of the reference facial image, and the noise vector. The video code is decoded by using a VAE decoder to obtain a plurality of video frames.

Finally, after the plurality of video frames are obtained, a target video is obtained based on the plurality of video frames.

In this aspect of this disclosure, any reference facial image can be driven by using audio or a video, to obtain a high-quality audio-driven talking head video, namely, the target video. In an example, no training data of the reference facial image is needed, providing strong generalization. In this way, the generated video has rich details, coherent frames, accurate lip movements, and a head motion trajectory that matches the prosody of the audio, making the entire target video more natural and realistic.

For the video generation method described above, this disclosure further provides a corresponding video generation apparatus, so that the foregoing video generation method can be applied and implemented in practice.

Referring to FIG. 8, FIG. 8 is a schematic structural diagram of a video generation apparatus according to an aspect of this disclosure. As shown in FIG. 8, the video generation apparatus 800 includes: an obtaining unit 801, a first determining unit 802, a second determining unit 803, an adjustment unit 804, and a generation unit 805.

The obtaining unit 801 is configured to obtain a reference facial image and a to-be-converted content sequence, the reference facial image comprising appearance features of a reference face, the to-be-converted content sequence comprising a plurality of pieces of to-be-converted content that change over time, and each piece of to-be-converted content being used for indicating facial motion features of an original face.

The first determining unit 802 is configured to determine a mesh model of the reference face according to the reference facial image.

The second determining unit 803 is configured to determine a mesh parameter difference sequence according to the to-be-converted content sequence, the mesh parameter difference sequence being used for identifying differences between the facial motion features indicated by the plurality of pieces of to-be-converted content.

The adjustment unit 804 is configured to adjust the mesh model of the reference face by using the mesh parameter difference sequence, to obtain a facial mesh model sequence.

The generation unit 805 is configured to generate a target video according to the facial mesh model sequence and the reference facial image.

As can be seen from the foregoing technical solution, the video generation apparatus provided in this aspect of this disclosure includes: an obtaining unit, a first determining unit, a second determining unit, an adjustment unit, and a generation unit. The obtaining unit obtains a reference facial image and a to-be-converted content sequence. The reference facial image includes appearance features of a reference face, the to-be-converted content sequence includes a plurality of pieces of to-be-converted content that change over time, and each piece of to-be-converted content is used for indicating facial motion features of an original face. The first determining unit determines a mesh model of the reference face according to the reference facial image. The mesh model of the reference face can explicitly represent external features of the reference face. The second determining unit determines a mesh parameter difference sequence according to the to-be-converted content sequence. The mesh parameter difference sequence is used for identifying differences between the facial motion features indicated by the plurality of pieces of to-be-converted content, e.g., reflecting changes in the facial motion features of the original face over time during sound production. The adjustment unit adjusts the mesh model of the reference face by using the mesh parameter difference sequence, e.g., adjusts the mesh model of the reference face by using the facial motion features of the original face. Therefore, instead of using fixed facial contour parameters, dynamic adjustment is performed by using the facial motion features that change over time, so that in a facial mesh model sequence obtained through adjustment, the appearance features of the reference face are better fused with the facial motion features of the original face. The generation unit generates a target video according to the facial mesh model sequence and the reference facial image, thereby improving the quality of the target video.

In an example of an implementation, the second determining unit 803 is configured to:

determine a mesh model sequence of the original face according to the to-be-converted content sequence, the mesh model sequence of the original face including a plurality of mesh models of the original face;

determine similarities between the plurality of mesh models of the original face and the mesh model of the reference face;

determine, among the plurality of mesh models of the original face, a mesh model whose similarity meets a similarity condition as a standard mesh model; and

obtain the mesh parameter difference sequence according to differences in facial motion features between each mesh model in the mesh model sequence of the original face and the standard mesh model.

In an example of an implementation, if an expression of the reference face is in a first state, the second determining unit 803 is configured to:

determine a mesh model sequence of the original face according to the to-be-converted content sequence, the mesh model sequence of the original face including a plurality of mesh models of the original face;

determine, among the plurality of mesh models of the original face, a mesh model whose expression conforms to the first state as a standard mesh model; and

obtain the mesh parameter difference sequence according to differences in facial motion features between each mesh model in the mesh model sequence of the original face and the standard mesh model.

In an example, the obtaining unit 801 is further configured to obtain a candidate reference facial image, an expression of a reference face in the candidate reference facial image being in a second state.

The apparatus further includes a preprocessing unit, configured to adjust facial motion features of the reference face in the candidate reference facial image based on the first state, to obtain the reference facial image.

In an example of an implementation, the generation unit 805 is configured to:

reproject the facial mesh model sequence to obtain a facial pose sequence; and

generate the target video according to the facial pose sequence and the reference facial image.

In an example, if the to-be-converted content sequence is audio, the apparatus further includes a third determining unit, configured to obtain a head pose vector sequence according to the to-be-converted content sequence, the head pose vector sequence including a plurality of pose vectors, and each pose vector being used for describing a position and an orientation of a head.

In an example, the generation unit 805 is configured to reproject the facial mesh model sequence and the head pose vector sequence to obtain the facial pose sequence.

In an example, if the to-be-converted content sequence is audio, the apparatus further includes a third determining unit, configured to perform conversion according to the to-be-converted content sequence by using an audio-to-pose-sequence model, to obtain the head pose vector sequence.

A training method for the audio-to-pose-sequence model is as follows:

obtaining a talking head video sample having a third label, the third label being used for identifying a head pose vector sequence of the talking head video sample;

performing conversion according to the talking head video sample by using an initial audio-to-pose-sequence model, to obtain a predicted head pose vector sequence; and

adjusting model parameters of the initial audio-to-pose-sequence model according to a difference between the predicted head pose vector sequence and the third label, to obtain the audio-to-pose-sequence model.

The audio-to-pose-sequence model may be obtained through training by a training unit included in the apparatus, or may be obtained through training by another apparatus. This is not specifically limited in this disclosure.

In an example of an implementation, the generation unit 805 is configured to:

perform feature extraction on the reference facial image to obtain image features of the reference facial image;

perform feature extraction on the facial mesh model sequence to obtain a facial feature sequence; and

generate the target video according to the image features and the facial feature sequence.

In an example of an implementation, the generation unit 805 is configured to:

obtain a noise vector for a facial feature in the facial feature sequence;

perform convolution calculation according to the noise vector by using a convolutional layer included in the diffusion model, to obtain shallow features;

perform feature fusion according to the shallow features and the facial feature by using a cross-attention layer included in the diffusion model, to obtain deep features;

perform feature fusion according to the deep features and the image features by using a stereo cross-attention layer included in the diffusion model, to obtain a video frame in the target video; and

generate the target video from video frames respectively obtained by using facial features included in the facial feature sequence.

In an example of an implementation, the generation unit 805 is configured to:

encode the reference facial image to obtain a reference facial image code, a data dimension of the reference facial image code being less than a data dimension of the reference facial image; and

perform feature extraction on the reference facial image code, to obtain the image features of the reference facial image;

generate a target video code according to the image features and the facial feature sequence; and

decode the target video code to obtain the target video.

In an example of an implementation, if the to-be-converted content is audio, the second determining unit 803 is configured to:

perform conversion according to the to-be-converted content sequence by using an audio-to-mesh-sequence model, to obtain the mesh parameter difference sequence.

A training method for the audio-to-mesh-sequence model is as follows:

obtaining a talking head video sample having a first label, the first label being used for identifying a mesh parameter difference sequence of the talking head video sample;

performing conversion according to the talking head video sample by using an initial audio-to-mesh-sequence model, to obtain a predicted mesh parameter difference sequence; and

adjusting model parameters of the initial audio-to-mesh-sequence model according to a difference between the predicted mesh parameter difference sequence and the first label, to obtain the audio-to-mesh-sequence model.

The audio-to-mesh-sequence model may be obtained through training by a training unit included in the apparatus, or may be obtained through training by another apparatus. This is not specifically limited in this disclosure.

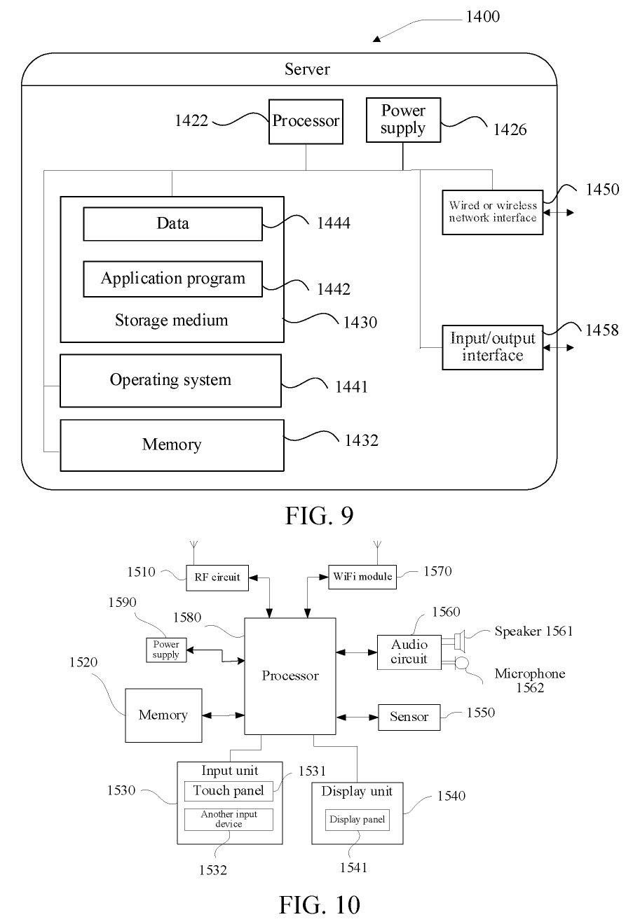

An aspect of this disclosure further provides a computer device. The computer device may be a server or a terminal device. The following describes the computer device provided in this aspect of this disclosure from the perspective of hardware entity. FIG. 9 is a schematic structural diagram of a server, and FIG. 10 is a schematic structural diagram of a terminal device.

FIG. 9 is a schematic structural diagram of a server according to an aspect of this disclosure. A server 1400 may vary greatly due to different configurations or performance, and may include one or more processors 1422, for example, one or more central processing units (CPUs), a memory 1432, and one or more storage media 1430 (for example, one or more mass storage devices) that store an application program 1442 or data 1444. The memory 1432 and the storage medium 1430 may be used for temporary storage or persistent storage. The program stored in the storage medium 1430 may include one or more modules (that are not shown in the figure), and each module may include a series of instruction operations on the server. Further, the processor 1422 may be configured to communicate with the storage medium 1430, and execute, on the server 1400, the series of instruction operations in the storage medium 1430.

The server 1400 may further include one or more power supplies 1426, one or more wired or wireless network interfaces 1450, one or more input/output interfaces 1458, and/or one or more operating systems 1441, for example, Windows Server^{TM}, Mac OS X^{TM}, Unix^{TM}, Linux^{TM}, FreeBSD^{TM}, and the like.

Operations performed by the server in the foregoing aspects may be based on the structure of the server shown in FIG. 9.

The processor 1422 is configured to perform the following operations:

obtaining a reference facial image and a to-be-converted content sequence, the reference facial image including appearance features of a reference face, the to-be-converted content sequence including a plurality of pieces of to-be-converted content that change over time, and each piece of to-be-converted content being used for indicating facial motion features of an original face;

determining a mesh model of the reference face according to the reference facial image;

determining a mesh parameter difference sequence according to the to-be-converted content sequence, the mesh parameter difference sequence being used for identifying differences between the facial motion features indicated by the plurality of pieces of to-be-converted content;

adjusting the mesh model of the reference face by using the mesh parameter difference sequence, to obtain a facial mesh model sequence; and

generating a target video according to the facial mesh model sequence and the reference facial image.

In some examples, the processor 1422 may further perform method steps of any implementation of the video generation method in the aspects of this disclosure.

FIG. 10 is a schematic structural diagram of a terminal device according to an aspect of this disclosure. An example in which the terminal device is a smartphone is used for description. FIG. 10 is a block diagram of a partial structure of the smartphone. The smartphone includes components such as a Radio Frequency (RF) circuit 1510, a memory 1520, an input unit 1530, a display unit 1540, a sensor 1550, an audio circuit 1560, a Wi-Fi module 1570, a processor 1580, and a power supply 1590. A person skilled in the art may understand that the structure, shown in FIG. 10, of the smartphone does not constitute a limitation on the smartphone, and the smartphone may include more or fewer components than those shown in the figure, or some components may be combined, or a different component deployment may be used.

In an example, the following describes the components of the smartphone with reference to FIG. 10.

The RF circuit 1510 may be configured to receive and transmit a signal during message reception and transmission or calling. Particularly, after receiving downlink information from a base station, the RF circuit 1510 transmits the information to the processor 1580 for processing. In addition, the RF circuit 1510 transmits related uplink data to the base station.

The memory 1520 may be configured to store a software program and a module. The processor 1580 runs the software program and the module that are stored in the memory 1520, to perform various functional applications and data processing of the smartphone.

The input unit 1530 may be configured to receive input digit or character information, and generate a key signal input related to user settings and function control of the smartphone. In some examples, the input unit 1530 may include a touch panel 1531 and another input device 1532. The touch panel 1531, also known as a touchscreen, may collect a touch operation of a user on or near the touch panel, and drive a corresponding connection apparatus according to a preset program. In addition to the touch panel 1531, the input unit 1530 may further include the other input device 1532. In some examples, the other input device 1532 may include, but is not limited to, one or more of a physical keyboard, a functional key (such as a volume control key and a switch key), a track ball, a mouse, a joystick, and the like.

The display unit 1540 may be configured to display information inputted by the user or information provided for the user, and various menus of the smartphone. The display unit 1540 may include a display panel 1541. In some aspects, the display panel 1541 may be configured in the form of a liquid crystal display (LCD), an organic light-emitting diode (OLED), and the like.

The smartphone may further include at least one sensor 1550, such as an optical sensor, a motion sensor, and other sensors. Other sensors that can be configured in the smartphone, such as a gyroscope, a barometer, a hygrometer, a thermometer, and an infrared sensor, are not further described herein.

The audio circuit 1560, a speaker 1561, and a microphone 1562 may provide an audio interface between the user and the smartphone. The audio circuit 1560 may convert received audio data into an electric signal and transmit the electric signal to the speaker 1561. The speaker 1561 converts the electric signal into a sound signal and outputs the sound signal. On the other hand, the microphone 1562 converts a collected sound signal into an electric signal. The audio circuit 1560 receives the electric signal and converts the electric signal into audio data, and outputs the audio data to the processor 1580 for processing. Then, the processor 1580 transmits the audio data to, for example, another smartphone, by using the RF circuit 1510, or outputs the audio data to the memory 1520 for further processing.

The processor 1580 is a control center of the smartphone, and is connected to various parts of the entire smartphone via various interfaces and lines. The processor 1580 executes various functions of the smartphone and performs data processing by running or executing a software program and/or a module stored in the memory 1520 and invoking data stored in the memory 1520. In some aspects, the processor 1580 may include one or more processing units.

The smartphone further includes the power supply 1590 for supplying power to various components. For example, the power supply 1590 may be logically connected to the processor 1580 by using a power management system, thereby implementing functions such as charging, discharging, and power consumption management by using the power management system.

Although not shown in the figure, the smartphone may further include a camera, a Bluetooth module, and the like, which are not described in further detail herein.

In this aspect of this disclosure, the memory 1520 included in the smartphone may store a computer program, and transmit the computer program to the processor.

The processor 1580 included in the smartphone may perform the video generation method provided in the foregoing aspects according to instructions in the computer program.

In addition, an aspect of this disclosure further provides a storage medium. The storage medium is configured to store a computer program. The computer program is configured to perform the video generation method provided in the foregoing aspects.

An aspect of this disclosure further provides a computer program product or a computer program. The computer program product or the computer program includes computer instructions, and the computer instructions are stored in a computer-readable storage medium. A processor of a computer device reads the computer instructions from the computer-readable storage medium, and the processor executes the computer instructions, to cause the computer device to perform the video generation method provided in the foregoing implementations.

A person of ordinary skill in the art may understand that all or some of the steps of the foregoing method aspects may be implemented by a program instructing relevant hardware. The foregoing program may be stored in a computer-readable storage medium. When the program runs, the steps of the foregoing method aspects are performed. The foregoing storage medium may be at least one of the following media: a Read-Only Memory (ROM), a Random Access Memory (RAM), a magnetic disk, an optical disc, or other media that can store a computer program.

In the aspect of this disclosure, the term "module" or "unit" may refer to a computer program with a preset function or a part of the computer program and works, together with other related parts, to implement a preset target, and may be completely or partially implemented by using software, hardware (for example, a processing circuit or a memory) or a combination thereof. Similarly, one processor (or a plurality of processors or memories) may be configured to realize one or more modules or units. In addition, each module or unit may be a part of an overall module or unit including the module or unit function.

One or more modules, submodules, and/or units of the apparatus can be implemented by processing circuitry, software, or a combination thereof, for example. The term module (and other similar terms such as unit, submodule, etc.) in this disclosure may refer to a software module, a hardware module, or a combination thereof. A software module (e.g., computer program) may be developed using a computer programming language and stored in memory or non-transitory computer-readable medium. The software module stored in the memory or medium is executable by a processor to thereby cause the processor to perform the operations of the module. A hardware module may be implemented using processing circuitry, including at least one processor and/or memory. Each hardware module can be implemented using one or more processors (or processors and memory). Likewise, a processor (or processors and memory) can be used to implement one or more hardware modules. Moreover, each module can be part of an overall module that includes the functionalities of the module. Modules can be combined, integrated, separated, and/or duplicated to support various applications. Also, a function being performed at a particular module can be performed at one or more other modules and/or by one or more other devices instead of or in addition to the function performed at the particular module. Further, modules can be implemented across multiple devices and/or other components local or remote to one another. Additionally, modules can be moved from one device and added to another device, and/or can be included in both devices.

The use of “at least one of” or “one of” in the disclosure is intended to include any one or a combination of the recited elements. For example, references to at least one of A, B, or C; at least one of A, B, and C; at least one of A, B, and/or C; and at least one of A to C are intended to include only A, only B, only C or any combination thereof. References to one of A or B and one of A and B are intended to include A or B or (A and B). The use of “one of” does not preclude any combination of the recited elements when applicable, such as when the elements are not mutually exclusive.

The aspects of this specification are all described in a progressive manner. For same or similar parts in between aspects, refer to each other. Descriptions of each aspect focus on a difference from other aspects. Especially, device and system aspects are basically similar to the method aspects, and therefore are described briefly; for related parts, refer to partial descriptions in the method aspects. The described device and system aspects are merely examples. The units described as separate parts may or may not be physically separated, and parts displayed as units may or may not be physical units, may be located in one position, or may be distributed on a plurality of network units. Some or all of the modules may be selected according to applications to achieve the objectives of the solutions of the aspects.

The foregoing descriptions are merely some examples of implementations of this disclosure, and are not intended to limit the scope of this disclosure. Variations or replacements shall fall within the scope of this disclosure. Moreover, this disclosure can provide more implementations by combining the implementations provided in the above aspects.

What is claimed is:

1. A video generation method, the method comprising:
obtaining a reference facial image and a to-be-converted content sequence, the reference facial image comprising appearance features of a reference face, the to-be-converted content sequence comprising a plurality of pieces of a to-be-converted content that changes over time, and each piece of the to-be-converted content indicating facial motion features of an original face associated with the to-be-converted content sequence;
determining a mesh model of the reference face according to the reference facial image;
determining a mesh parameter difference sequence according to the to-be-converted content sequence, the mesh parameter difference sequence indicating changes of the facial motion features over time;
adjusting the mesh model of the reference face based on the mesh parameter difference sequence to obtain a facial mesh model sequence; and
generating a target video according to the facial mesh model sequence and the reference facial image.

2. The method according to claim 1, wherein the determining the mesh parameter difference sequence comprises:
determining a mesh model sequence of the original face according to the to-be-converted content sequence, the mesh model sequence of the original face comprising a plurality of mesh models of the original face;
determining a similarity between each of the plurality of mesh models of the original face and the mesh model of the reference face;
determining, among the plurality of mesh models of the original face and according to the determined similarities, a mesh model whose similarity meets a similarity condition as a standard mesh model; and
obtaining the mesh parameter difference sequence according to a difference between each mesh model in the mesh model sequence of the original face and the standard mesh model.

3. The method according to claim 1, wherein when an expression of the reference face is in a first state, the determining the mesh parameter difference sequence comprises:
determining a mesh model sequence of the original face according to the to-be-converted content sequence, the mesh model sequence of the original face comprising a plurality of mesh models of the original face;
determining, among the plurality of mesh models of the original face, a mesh model whose expression conforms to the first state as a standard mesh model; and
obtaining the mesh parameter difference sequence according to a difference between each mesh model in the mesh model sequence of the original face and the standard mesh model.

4. The method according to claim 3, further comprising:
obtaining a candidate reference facial image, the expression of the reference face in the candidate reference facial image being in a second state; and
adjusting the facial motion features of the reference face in the candidate reference facial image based on the first state to obtain the reference facial image.

5. The method according to claim 1, wherein the generating the target video comprises:
reprojecting the facial mesh model sequence to obtain a facial pose sequence; and
generating the target video according to the facial pose sequence and the reference facial image.

6. The method according to claim 5, wherein when the to-be-converted content sequence is an audio sequence, the method further comprises:
obtaining a head pose vector sequence according to the audio sequence, the head pose vector sequence comprising a plurality of pose vectors, and each pose vector indicating a respective position and a respective orientation of a head; and
the reprojecting comprises:
reprojecting the facial mesh model sequence and the head pose vector sequence to obtain the facial pose sequence.

7. The method according to claim 6, wherein
the obtaining the head pose vector sequence includes converting, using an audio-to-pose-sequence model, the audio sequence to the head pose vector sequence; and
the method includes:
obtaining a talking head video sample having a third label indicating a head pose vector sequence of the talking head video sample;
converting, with an initial audio-to-pose-sequence model, the talking head video sample to a predicted head pose vector sequence; and
adjusting model parameters of the initial audio-to-pose-sequence model according to a difference between the predicted head pose vector sequence and the third label to obtain the audio-to-pose-sequence model.

8. The method according to claim 1, wherein the generating the target video comprises:
performing feature extraction on the reference facial image to obtain image features of the reference facial image;
performing feature extraction on the facial mesh model sequence to obtain a facial feature sequence; and
generating the target video according to the image features and the facial feature sequence.

9. The method according to claim 8, wherein the generating the target video according to the image features and the facial feature sequence comprises:
obtaining a noise vector for a facial feature in the facial feature sequence;
performing convolution calculation according to the noise vector with a convolutional layer in a diffusion model to obtain shallow features;
performing feature fusion according to the shallow features and the facial feature with a cross-attention layer in the diffusion model to obtain deep features;
performing feature fusion according to the deep features and the image features with a stereo cross-attention layer in the diffusion model to obtain a video frame in the target video; and
generating the target video from video frames respectively obtained by using facial features comprised in the facial feature sequence.

10. The method according to claim 8, wherein
the performing the feature extraction on the reference facial image comprises:
encoding the reference facial image to obtain a reference facial image code, a data dimension of the reference facial image code being less than a data dimension of the reference facial image; and
performing feature extraction on the reference facial image code to obtain the image features of the reference facial image;
the generating the target video according to the image features and the facial feature sequence comprises:
generating a target video code according to the image features and the facial feature sequence; and
decoding the target video code to obtain the target video.

11. The method according to claim 1, wherein
when the to-be-converted content is an audio sequence, the determining the mesh parameter difference sequence includes:
converting the audio sequence with an audio-to-mesh-sequence model to obtain the mesh parameter difference sequence; and
the method includes training the audio-to-mesh-sequence model including:
obtaining a talking head video sample having a first label indicating a mesh parameter difference sequence of the talking head video sample;
converting the talking head video sample with an initial audio-to-mesh-sequence model to obtain a predicted mesh parameter difference sequence; and
adjusting model parameters of the initial audio-to-mesh-sequence model according to a difference between the predicted mesh parameter difference sequence and the first label to obtain the audio-to-mesh-sequence model.

12. A video generation apparatus, comprising:
processing circuitry configured to:
obtain a reference facial image and a to-be-converted content sequence, the reference facial image comprising appearance features of a reference face, the to-be-converted content sequence comprising a plurality of pieces of a to-be-converted content that changes over time, and each piece of the to-be-converted content indicating facial motion features of an original face associated with the to-be-converted content sequence;
determine a mesh model of the reference face according to the reference facial image;
determine a mesh parameter difference sequence according to the to-be-converted content sequence, the mesh parameter difference sequence indicating changes of the facial motion features over time;
adjust the mesh model of the reference face based on the mesh parameter difference sequence to obtain a facial mesh model sequence; and
generate a target video according to the facial mesh model sequence and the reference facial image.

13. The apparatus according to claim 12, wherein the processing circuitry is configured to:
determine a mesh model sequence of the original face according to the to-be-converted content sequence, the mesh model sequence of the original face comprising a plurality of mesh models of the original face;
determine a similarity between each of the plurality of mesh models of the original face and the mesh model of the reference face;
determine, among the plurality of mesh models of the original face and according to the determined similarities, a mesh model whose similarity meets a similarity condition as a standard mesh model; and
obtain the mesh parameter difference sequence according to a difference between each mesh model in the mesh model sequence of the original face and the standard mesh model.

14. The apparatus according to claim 12, wherein when an expression of the reference face is in a first state, the processing circuitry is configured to:
determine a mesh model sequence of the original face according to the to-be-converted content sequence, the mesh model sequence of the original face comprising a plurality of mesh models of the original face;
determine, among the plurality of mesh models of the original face, a mesh model whose expression conforms to the first state as a standard mesh model; and
obtain the mesh parameter difference sequence according to a difference between each mesh model in the mesh model sequence of the original face and the standard mesh model.

15. The apparatus according to claim 14, wherein the processing circuitry is configured to:
obtain a candidate reference facial image, the expression of the reference face in the candidate reference facial image being in a second state; and
adjust the facial motion features of the reference face in the candidate reference facial image based on the first state to obtain the reference facial image.

16. The apparatus according to claim 12, wherein the processing circuitry is configured to:
reproject the facial mesh model sequence to obtain a facial pose sequence; and
generate the target video according to the facial pose sequence and the reference facial image.

17. The apparatus according to claim 16, wherein when the to-be-converted content sequence is an audio sequence, the processing circuitry is configured to:
obtain a head pose vector sequence according to the audio sequence, the head pose vector sequence comprising a plurality of pose vectors, and each pose vector indicating a respective position and a respective orientation of a head; and
reproject the facial mesh model sequence and the head pose vector sequence to obtain the facial pose sequence.

18. The apparatus according to claim 12, wherein the processing circuitry is configured to:
perform feature extraction on the reference facial image to obtain image features of the reference facial image;
perform feature extraction on the facial mesh model sequence to obtain a facial feature sequence; and
generate the target video according to the image features and the facial feature sequence.

19. The apparatus according to claim 12, wherein the processing circuitry is configured to:
convert an audio sequence using an audio-to-mesh-sequence model to obtain the mesh parameter difference sequence when the to-be-converted content is the audio sequence;
obtain a talking head video sample having a first label indicating a mesh parameter difference sequence of the talking head video sample;
convert the talking head video sample using an initial audio-to-mesh-sequence model to obtain a predicted mesh parameter difference sequence; and
adjust model parameters of the initial audio-to-mesh-sequence model according to a difference between the predicted mesh parameter difference sequence and the first label to obtain the audio-to-mesh-sequence model.

20. A non-transitory computer-readable storage medium storing instructions which when executed by at least one processor cause the at least one processor to perform:
obtaining a reference facial image and a to-be-converted content sequence, the reference facial image comprising appearance features of a reference face, the to-be-converted content sequence comprising a plurality of pieces of a to-be-converted content that changes over time, and each piece of the to-be-converted content indicating facial motion features of an original face associated with the to-be-converted content sequence;
determining a mesh model of the reference face according to the reference facial image;
determining a mesh parameter difference sequence according to the to-be-converted content sequence, the mesh parameter difference sequence indicating changes of the facial motion features over time;
adjusting the mesh model of the reference face based on the mesh parameter difference sequence to obtain a facial mesh model sequence; and
generating a target video according to the facial mesh model sequence and the reference facial image.
